(19) United States
(12) Patent Application Publication
(10) Pub. No.: US 2026/0100970 A1
(43) Pub. Date: Apr. 9, 2026

(54) Determining and Enforcing Data Location of Internet Traffic Routing Using Transport Layer Security (TLS) Server Name Indication (SNI)

(71) Applicant: CLOUDFLARE, INC., SAN FRANCISCO, CA (US)

(72) Inventors: Thomas Graham Arnfeld, Kingston, NY (US); Nicholas Jones, Lousã (PT)

(21) Appl. No.: 18/907,378

(22) Filed: Oct. 4, 2024

(51) Int. Cl. H04L 9/40

(52) U.S. Cl. CPC H04L 63/166; H04L 63/0823

(57) ABSTRACT

A compute server receives a secure session request as part of a secure session handshake. The request includes a Server Name Indication (SNI) field. The compute server determines a hostname from the SNI field and determines that a policy is applicable for the determined hostname. The policy indicates a first location where decrypting and servicing traffic for the determined hostname is permitted. The compute server determines that its location does not satisfy the determined policy. The compute server proxies the secure session handshake between the client network application and a second server that satisfies the determined policy. The compute server proxies layer 4 traffic transmitted over the secure session between the client network application and the second server.

### FIELD

Embodiments of the invention relate to the field of cloud computing; and more specifically, to determining and enforcing data location of internet traffic routing using Transport Layer Security (TLS) Server Name Indication (SNI).

### BACKGROUND

Cloud based networks can include data centers that are geographically distributed. Requests from internet client devices are transmitted to origin servers to fetch the content that the user is requesting. This traffic may pass through the cloud based network, which may engage in significant activities such as decrypting and servicing that traffic. Some website operators want or are required to have location-based restrictions for the services provided by the cloud providers that they use. For instance, some website operators need or want to define where data is decrypted and serviced to meet compliance obligations or preferences. There are regional services solutions in some cloud based networks that provide the ability to accommodate regional restrictions by allowing the website operator to choose which subset of data centers decrypt and service traffic. These solutions work by using an IP based solution where certain IP addresses are used for certain locations. Any traffic that is received at one of these IP addresses at a data center that is not an allowed data center is proxied to another data center that is allowed to decrypt and service the traffic.

### SUMMARY

A compute server receives a secure session request as part of a secure session handshake. The request includes a Server Name Indication (SNI) field. The compute server determines a hostname from the SNI field and determines that a policy is applicable for the determined hostname. The policy indicates a first location where decrypting and servicing traffic for the determined hostname is permitted. The compute server determines that its location does not satisfy the determined policy. The compute server proxies the secure session handshake between the client network application and a second server that satisfies the determined policy. The compute server proxies layer 4 traffic transmitted over the secure session between the client network application and the second server.

### BRIEF DESCRIPTION OF THE DRAWINGS

The invention may best be understood by referring to the following description and accompanying drawings that are used to illustrate embodiments of the invention. In the drawings:

FIG. 1 illustrates a distributed cloud computing network according to an embodiment.

FIG. 2 shows an example of determining and enforcing data location of internet traffic routing using TLS SNI according to an embodiment.

FIG. 3 is a flow diagram that illustrates exemplary operations for determining and enforcing data location of internet traffic routing using TLS SNI according to an embodiment.

FIG. 4 is a block diagram illustrating a data processing system that can be used in an embodiment.

### DESCRIPTION OF EMBODIMENTS

A method and system for determining and enforcing data location of internet traffic routing using Transport Layer Security (TLS) Server Name Indication (SNI) is described. A secure session request (e.g., a ClientHello message) as part of a secure session handshake to establish a secure session is received at a first server of a distributed cloud computing network. The secure session request originates from a client network application. The secure session request includes an SNI field. The first server is one or many servers of the distributed cloud computing network. The first server may be part of a first region of multiple regions of the distributed cloud computing network. The first server determines the hostname based on the SNI field of the secure session request. Based on the determined hostname, the first server determines whether a policy applies and if so, the policy is enforced.

As an example, the policy may define a location where traffic is allowed to be decrypted and serviced in the distributed cloud computing network. For instance, a policy may define that traffic destined for a particular hostname is only to be decrypted and serviced in the United States. If the first server does not meet the defined location for processing the request, the first server proxies the secure session handshake between the client network application and a second server of the distributed cloud computing network that satisfies the defined location. Proxying the secure session handshake includes the first server transmitting any existing data it has received from the client network application to the second server such as the secure session request (e.g., ClientHello message). The transmitted data may be un modified. The messages sent as part of the secure session handshake may include a ClientHello message from the client network application, a ServerHello message sent in response to the Client Hello, and a Finished message sent by the server. A successful secure session handshake creates a secure session between the client network application and the second server. The first server, not being part of the secure session handshake, cannot read the decrypted content of traffic sent between the client network application and the second server over the established secure session. The first server proxies the layer 4 traffic transmitted over the secure session between the client network application and the second server.

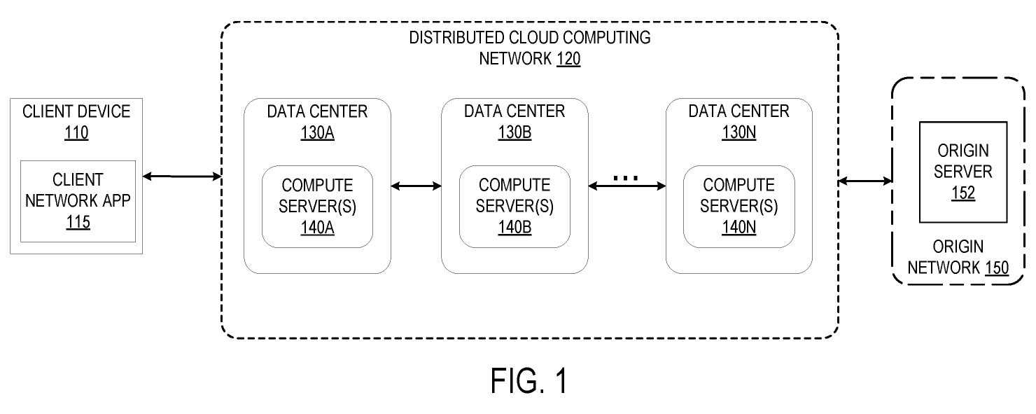

FIG. 1 illustrates a distributed cloud computing network according to an embodiment. The distributed cloud computing network 120 includes the data centers 130A-N. The data centers 130A-N are geographically distributed and may be in different locations. The data centers 130A-N each include one or more compute servers 140A-N respectively. Each data center 130 can also include one or more control servers, one or more DNS servers (e.g., one or more authoritative name servers, one or more proxy DNS servers), and/or one or more other pieces of network equipment such as router(s), switch(es), and/or hubs. In an embodiment, each compute server 140 within a data center 130 may process IP traffic (e.g., HTTP/S, SPDY, FTP, TCP, UDP, IPSec, SIP, or other IP protocol traffic). The data centers 130A-N are connected across the public internet.

The system also includes the origin network 150 that includes the origin server 152. The origin network 150 is the origin for IP traffic and is a destination that is external to the distributed cloud computing network 120. The origin server 152 is a computing device on which a network resource resides and/or originates (e.g., web pages, images, word processing documents, PDF files, movie files, music files, or other computer files). Client devices, such as the client device 110, access network resources of the origin server 152 through the distributed cloud computing network 120. A client device 110 is a computing device (e.g., laptop, desktop, smartphone, mobile phone, tablet, gaming system, wearable device, Internet-of-Things (IoT) device, set-top box, etc.) that can access network resources through a client network application 115 (e.g., a browser, a mobile application, or other network application).

Network traffic is received at the distributed cloud computing network 120 from client devices such as the client device 110. The network traffic may be destined to a customer of the distributed cloud computing network 120 and served by the origin server 152. The traffic may be received at the distributed cloud computing network 120 in different ways. For instance, IP address(es) of the origin network 150 belonging to the customer may be advertised (e.g., using Border Gateway Protocol (BGP)) by the distributed cloud computing network 120 instead of being advertised by the origin network 150. As another example, the data centers 130A-N of the distributed cloud computing network 120 may advertise a different set of anycast IP address(es) on behalf of the origin and map those anycast IP address(es) to the origin IP address(es). This causes IP traffic to be received at the distributed cloud computing network 120 instead of being received at the origin network 150. As another example, network traffic for a hostname of the origin network 150 may be received at the distributed cloud computing network 120 due to a DNS request for the hostname resolving to an IP address of the distributed cloud computing network 120 instead of resolving to an IP address of the origin network. As another example, client devices may be configured to transmit traffic to the distributed cloud computing network 120. For example, an agent on the client device (e.g., a VPN client) may be configured to transmit traffic to the distributed cloud computing network 120. As another example, a browser extension or file can cause the traffic to be transmitted to the distributed cloud computing network 120.

In any of the above scenarios, the network traffic from the client device 110 may be received at a particular datacenter 130 that is determined to be closest to the client device 110 in terms of routing protocol configuration (e.g., Border Gateway Protocol (BGP) configuration) according to an anycast implementation as determined by the network infrastructure (e.g., router(s), switch(es), and/or other network equipment between the client device 110 and the datacenters 130A-N) or by a geographical load balancer.

Each of the compute servers 140A-N may be assigned a set of one or more compute server identities including a location identity, a data center identity, an identifier identity, a data center tier type identity, a server manufacturer identity, a server/data center certification identity (e.g., an ISO-certified identity, a FedRAMP identity, etc.), and/or a server generation identity. These identities are exemplary as the compute servers may be assigned other identities based on properties or features of the compute servers.

The location identity may identify the location in which the compute server and/or data center is located. The location may be a street, a neighborhood, a city, a state, a country, a zip code, a region, GPS coordinates, a continent, a legal jurisdiction, or determined by a custom map that allows the customer to define the location. The country value is used to identify the country in which the compute server and/or data center is located. The legal jurisdiction value is used to identify the legal jurisdiction in which the compute server and/or data center is located. The legal jurisdiction identity may be a state, a country, a set of countries/states that are joined together (e.g., the European Union). The region value is used to identify the region in which the compute server and/or data center is located. The regions may be defined by the service provider of the distributed cloud computing network and may, at least loosely, correspond with geographic regions. An example region may be Europe. Another example region is the Americas (including North and South America). The regions may also be defined by the customer of the distributed cloud computing network.

The data center identity may identify the data center of which the compute server is a member. The data center identity may be a number, a name, or other identifier. A data center may include multiple compute servers. The identifier identity may identify a particular compute server. Each compute server may have a unique identifier. The data center tier type identity is used for identifying the tier of the data center of which the compute server is a member. In an embodiment, there are multiple data center tiers that represent the relative quality and/or security of the data center. For instance, a tier 1 data center may have relatively higher performance and/or security as compared to a tier 2 data center.

The server manufacturer identity is used to identify the manufacturer of the compute server or a particular component of the compute server (e.g., the processing system of the compute server). Different compute servers may have different manufacturers that may have different processing and/or security capabilities. The server generation identity is used to identify the generation of the compute server which may be used to determine the capabilities of that server (e.g., newer servers may have different capabilities than older servers).

The server/data center certification identity is used to identify whether and/or which certifications the server and/or data center have (e.g., ISO-certified, FedRAMP certified). It is possible for a server and/or data center to have multiple certifications by different organizations. The certification may be made by an independent body and/or by the service provider of the distributed cloud computing network. The certifications may include whether the server and/or data center meet certain physical controls (e.g., physically secure with perimeter controls, restricted facility access, onsite security, CCTV, secured server cabinet including locks and physical tamper detection), biometric controlled facility access, whether the servers are in private cages, whether the points of ingress/egress are monitored by an intrusion detection system.

Although not illustrated in FIG. 1, the distributed cloud computing network 120 may include a control server that provides a set of tools and interfaces for a customer to, among other things, configure one or more policies for decrypting and servicing traffic belonging to the customer. The one or more policies may include any combination of the identities assigned to the compute servers. For example, the one or more policies may include a location policy that defines location(s) where traffic is allowed to be decrypted and serviced in the distributed cloud computing network 120. Such a policy can be an allow list or a deny list. Such a policy can be scoped to a particular hostname. As another example, the one or more policies may include a server/data center certification identity that indicates a certification level for decrypting and servicing traffic.

The policy or policies that apply can be defined by the service provider of the distributed cloud computing network and selected by the customer, and/or defined by the customer. The control server can provide an API that can be used by a customer to define a policy. The policy may be defined through an expression language (e.g., country IN (a, b, c) AND is_fedramp), or may be a structure that has a list of members (e.g,. list of countries). These policy(ies) are associated with the customer account and can be reused and shared among different hostnames. The distributed cloud computing network may map the policy(ies) to its topology to instruct how the traffic should be routed. This information can be provided to the compute servers of the distributed cloud computing network. Alternatively, the policy expression can be provided to the compute servers which then evaluates whether the policy is satisfied and if not determines where to route the data. The policy(ies) can be defined and managed centrally and distributed to the compute servers via a distributed data store (e.g., a distributed key-value store).

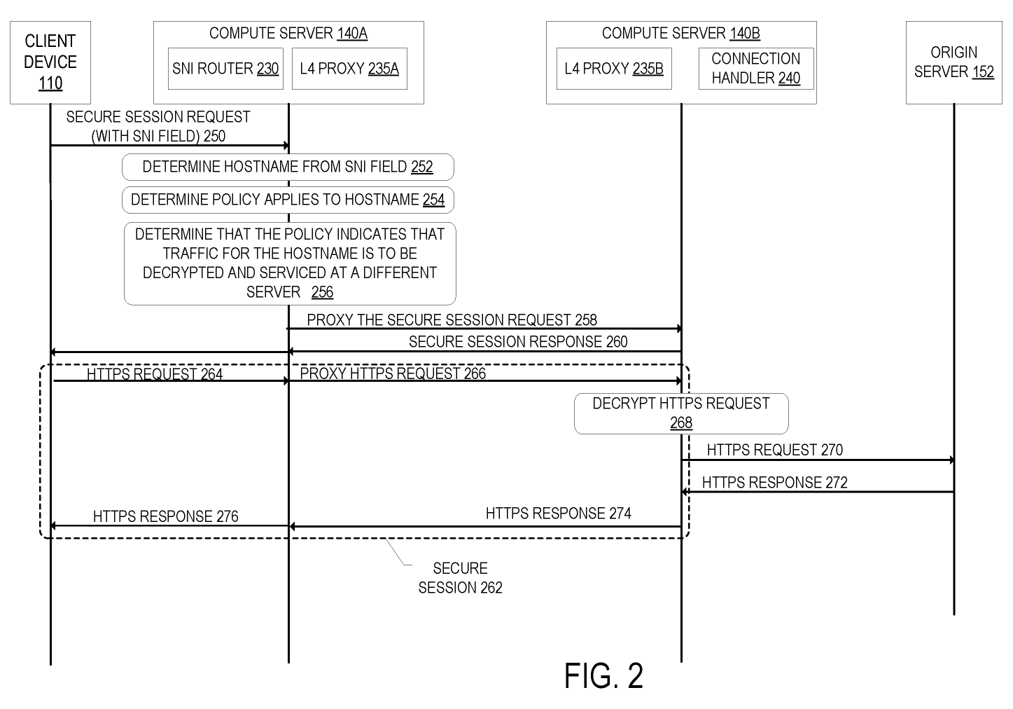

FIG. 2 shows an example of determining and enforcing data location of internet traffic routing using TLS SNI according to an embodiment. At operation 250, the compute server 140A receives a secure session request (e.g., a ClientHello message) from the client device 110. The secure session request includes an SNI field. The secure session request may be received at the compute server 140A (at the data center 130A) because it is the closest to the client device 110 in terms of routing protocol configuration according to an anycast implementation as determined by the network infrastructure or by a geographical load balancer.

The compute server 140A includes the SNI router 230. The SNI router 230 determines the hostname from the SNI field at operation 252. As an example throughout FIG. 2, the determined hostname is eu.example.com. The SNI router 230 may also retrieve the certificate for the determined hostname. In an embodiment, the SNI router 230 determines whether the hostname is served over a dedicated certificate that does include Common Name (CN) and/or Subject Alternative Names (SANs) for other hostname(s). If the certificate covers other hostname(s) with different policies, the SNI router 230 or connection handler 240 may refuse to perform the remaining operations shown in FIG. 2. The SNI router 230 or connection handler 240 may return an error in this case.

In an embodiment, the SNI router 230 can determine which certificate is going to be served by the connection handler without decrypting the stream. Retrieving the certificate may also retrieve information about the certificate such as the CN and/or SAN which may be unencrypted. The private key included in the certificate may be encrypted, which the SNI router 230 will not attempt to decrypt before policy determination. After determining the CN and/or SAN, the SNI router 230 may choose to proceed with the operations shown in FIG. 2. The SNI router 230 may not have the certificate information available. In such a case, this validation step may be performed by another process on the compute server 140A (e.g., the connection handler 240) or may be proxied to another compute server that matches the determined policy that has or is permitted to have the certificate information available.

Prior to deployment of the certificate, which includes the encrypted private key and the CN and/or SAN), the certificate issuing pipeline may also enforce these same CN and/or SAN rules. The certificate issuing pipeline may be running in a central server of the distributed cloud computing network and the certificates may be available to the compute servers via a distributed data store (e.g., a distributed key-value store). The certificate issuing pipeline ensures and validates consistency between the certificate used and the hostname policy. The certificate issuing pipeline may choose to generate additional certificate(s) that satisfy the policy such that SNI router 230 or connection handler 240 do not return an error as described above.

As an example, a certificate may exist with a CN www.example.com and a SAN static.example.com where there is no policy attached to either hostname. At a later time, a policy may be created (e.g., decrypt and service traffic only in the EU region) for only www.example.com, violating the consistency constraint between the certificate and the policy. The certificate issuing pipeline may automatically generate new dedicated certificates for each CN/SAN such that www.example.com and static.example.com are not served on the same certificate.

The SNI router 230 determines that a policy applies for the determined hostname at operation 254. For example, prior to the operations of FIG. 2, a policy for decrypting and servicing traffic for the hostname eu.example.com has been defined. As an example, this policy may define that traffic for the hostname eu.example.com is only allowed to be decrypted and serviced at compute servers within the EU region (e.g., countries in Europe). In an embodiment, the policy is retrieved through a key-value store (e.g., a distributed key-value store). In another embodiment, retrieving the certificate also includes metadata that describes the policy to apply. For example, the metadata can be in the form of a key-value pair where the value describes the location (e.g., {“region_key”: “us”}). The SNI router 230 determines whether the compute server that receives the secure session request is permitted, via the policy, to decrypt and service the traffic. If it is not, then the SNI router 230 will proxy the traffic to another server that is permitted to decrypt and service the traffic. In the example of FIG. 2, at operation 256, the SNI router 230 determines that the policy indicates that traffic for the hostname is to be decrypted and serviced at a different server. Thus, the compute server 140A is not permitted, via the policy, to decrypt and service traffic for the hostname. As an example, the compute server 140A is outside of the EU region (e.g., it is within the United States).

The SNI router 230 determines where to proxy the traffic, including the secure session request, for decrypting and servicing at the distributed cloud computing network 120. The destination of the proxied traffic may be in the same data center of the SNI router 230 or may be in a different data center of the SNI router 230 (e.g., depending on the policy). As an example, if the policy defines a location for decrypting and servicing traffic for the hostname, the SNI router 230 can determine a compute server and/or data center of that location for processing the traffic based on a mapping periodically received by the compute server 140A. In the example of FIG. 2, the compute server 140B is permitted via the defined policy to decrypt and service the traffic for the hostname eu.example.com (e.g., it is within the EU region). If there are multiple compute servers and/or data centers that are permitted for decrypting and servicing traffic for the hostname, the SNI router 230 may select one to proxy the traffic.

The compute server 140A proxies the traffic to a compute server that is permitted to decrypt and service traffic for the hostname. The SNI router 230 sends the traffic to the L4 proxy 235A on the compute server 140A. The SNI router 230 can also include the original client data (e.g., the client IP address, the client port, the server IP address, and the server port) from the secure session request. The SNI router 230 may also include information for the L4 proxy 235A to proxy the traffic to the correct location. For example, the SNI router 230 may include the target destination (e.g., the specific compute server, the specific data center, a location) for the proxied traffic. The SNI router 230 can also transmit information about the policy that applies for use by a later system to enforce the policy without having to lookup the policy again. Such information about the policy can be an identifier or name of the policy for quick retrieval or an encoded description of the policy (e.g,. “eu” (which represents only being allowed in the EU region), “country IN (a, b, c)” (which represents being allowed in the countries a, b, or c)).

The L4 proxy 235A on the compute server 140A proxies the layer 4 packets to another L4 proxy 235B on the compute server 140B. The connection between the L4 proxy 235A and the L4 proxy 235B may be an mTLS encrypted tunnel. The L4 proxy 235A can also include the client IP address and port, and the server IP address and port from the secure session request.The L4 proxy 235A can also transmit information about the policy to the L4 proxy 235B such as an identifier or name of the policy for quick policy retrieval or an encoded description of the policy (e.g,. “eu” (which represents only being allowed in the EU region), “country IN (a, b, c)” (which represents being allowed in the countries a, b, or c)).

Thus, at operation 258, the L4 proxy 235A proxies the secure session request to the L4 proxy 235B. The L4 proxy 235B receives the secure session request and passes it to the connection handler 240 of the compute server 140B. The connection handler 240 terminates the secure session between the client device 110 and the compute server 140B. The connection handler 240 stores the client IP address, client port, server IP address, and server port in memory. The connection handler 240 responds to the secure session request with a secure session response (e.g., a ServerHello message and a Finished message). The secure session response is passed back to the L4 proxy 235B which proxies the secure session response back to the L4 proxy 235A at operation 260. The secure session response is then sent to the client device 110 by the compute server 140A. Depending on the version of TLS used and/or the options that are used, there may be other messages proxied between the client device 110 and the compute server 140B that are proxied by the compute server 140A in a similar way. After the secure session handshake is complete, the secure session 262 is created between the client device 110 and the compute server 140B. The compute server 140A is not able to read the data sent over the secure session 262.

Sometime later, the client device 110 transmits an HTTPS request for the hostname (e.g., eu.example.com) over the secure session 262 at operation 264. The compute server 140A cannot decrypt the HTTPS request and may not be aware that the packets received are for an HTTPS request. The L4 proxy 235A proxies the received L4 packets (the HTTPS request) to the L4 proxy 235B of the compute server 140B at operation 266. The L4 proxy 235B passes the proxied L4 packets to the connection handler 240, which decrypts the HTTPS request at operation 268. The connection handler 240 then services the HTTP request, which may include transmitting a request and receiving a response from the origin server 152 if the requested content is not available in cache. The connection handler 240 retrieves the original client data (e.g., the client IP address, client port, server IP address, and server port) from memory and transmits this information to the origin server 152. The example shown in FIG. 2 assumes that the content requested in the HTTP request is not available in cache. Thus, at operation 270, the connection handler 240 transmits the HTTP request to the origin server 152, and receives an HTTP response from the origin server 152 at operation 272. The connection between the connection handler 240 and the origin server 152 may also be over TLS.

The connection handler 240 generates the HTTPS response and the L4 proxy 235B transmits the HTTPS response to the L4 proxy 235A at operation 274. The compute server 140A proxies the HTTP response back to the client device 110 at operation 276. This process continues during the secure session.

Although FIG. 2 described the SNI router 230 determining where to proxy the traffic, in an embodiment the SNI router 230 determines the location, which is provided to the L4 proxy 235A, and the L4 proxy 235A determines how to connect to a particular data center or compute server for the provided location.

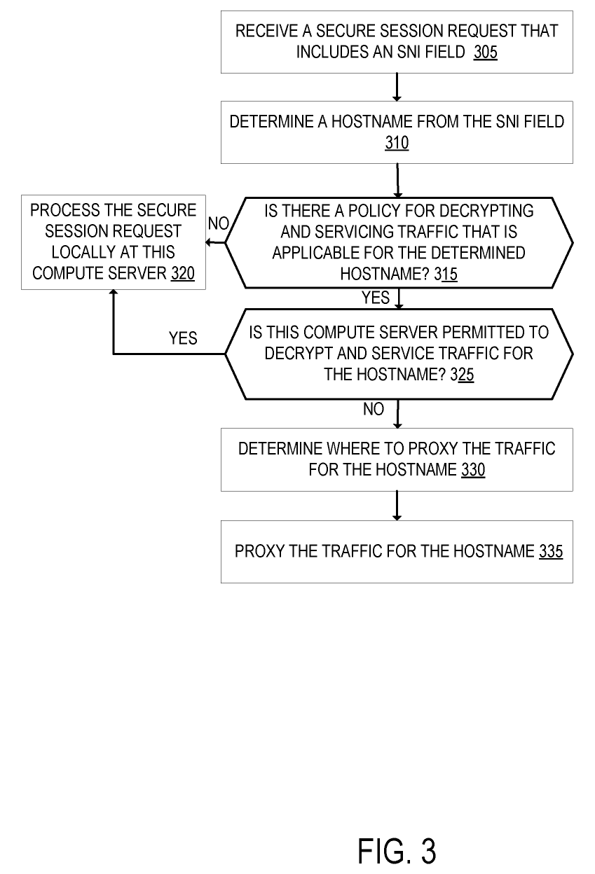

FIG. 3 is a flow diagram that illustrates exemplary operations for determining and enforcing data location of internet traffic routing using TLS SNI according to an embodiment. The operations of FIG. 3 are described with reference to the exemplary embodiments of the other figures. However, the operations of FIG. 3 can be performed by embodiments different from that of the other figures, and the exemplary embodiments of the other figures can perform operations different from that of FIG. 3.

At operation 305, a first compute server 140A of the distributed cloud computing network 120 receives a secure session request that originates from a client network application 115 of a client device 110. The secure session request includes an SNI field. The secure session request may be a ClientHello message. The secure session request may be received at the first compute server 140A as a result of an anycast implementation. Next, at operation 310, the first compute server 140A determines a hostname from the SNI field. In an embodiment, the first compute server 140A also retrieves metadata for the certificate for the hostname and determines whether it is a dedicated certificate that does not cover any other hostname that has a different policy. If it is a dedicated certificate or it is a shared certificate with hostname(s) that have the same policy, then the operations continue. If it is a shared certificate with one or more other hostnames and those hostname(s) have a different policy, then the further operations of FIG. 3 are not performed.

At operation 315, the first compute server 140A determines whether there is a policy for decrypting and servicing traffic that is applicable for the determined hostname. There may be multiple policies that are applicable for the determined hostname. The policies can include any combination of the identities assigned to the compute servers. As an example, such a policy can indicate a location where decrypting and servicing traffic for the determined hostname is permitted.

If there is not a policy for decrypting and servicing traffic that is applicable for the determined hostname, then operation 320 is performed where the first compute server 140A processes the secure session request locally. For example, the first compute server 140A participates in the secure session handshake with the client network application to create a secure session. After creating the secure session, the first compute server 140A decrypts an HTTPS request and services the traffic.

If there is a policy for decrypting and servicing traffic that is applicable for the determined hostname, then operation 325 is performed. At operation 325, the first compute server 140A determines whether it is permitted to decrypt and service traffic for the hostname. To say it another way, the first compute server 140A determines whether it satisfies the determined policy. If the first compute server 140A is permitted, then operation 320 is performed. If the first compute server 140A is not permitted to decrypt and service traffic for the hostname, then operation 330 is performed.

At operation 330, the first compute server 140A determines where to proxy the traffic for the hostname. The first compute server 140A may periodically receive a mapping that maps the hostname with the location of compute server(s) and/or data center(s) that meet the policy. If there are multiple compute servers and/or data centers that are permitted for decrypting and servicing traffic for the hostname, the first compute server 140A may select one to proxy the traffic.

Next, at operation 335, the first compute server 140A proxies the traffic for the hostname to another compute server 140B of the distributed cloud computing network 120 that is permitted to decrypt and service the traffic for the hostname. The first compute server 140A may include the client IP address, client port, server IP address, and server port, from the secure session request when proxying the traffic to the compute server 140B. The first compute server 140A may also transmit information about the policy to the compute server 140B such as an identifier or name of the policy for quick policy retrieval or an encoded description of the policy (e.g,. “eu” (which represents only being allowed in the EU region), “country IN (a, b, c)” (which represents being allowed in the countries a, b, or c)).

Proxying the traffic includes proxying the secure session handshake between the client network application 115 and the compute server 140B and any subsequent data traffic (e.g., HTTPS requests and responses) between the client network application 115 and the compute server 140B. The connection between the first compute server 140A and the second compute server 140B may be over an mTLS connection.

Although embodiments have been described with respect to HTTP traffic, the techniques described herein can be used for non-HTTP traffic where the client network application uses TLS and SNI. For example, the techniques described herein can be used for any TCP or QUIC stream wrapped in TLS, such as DNS-over-TLS (DoT).

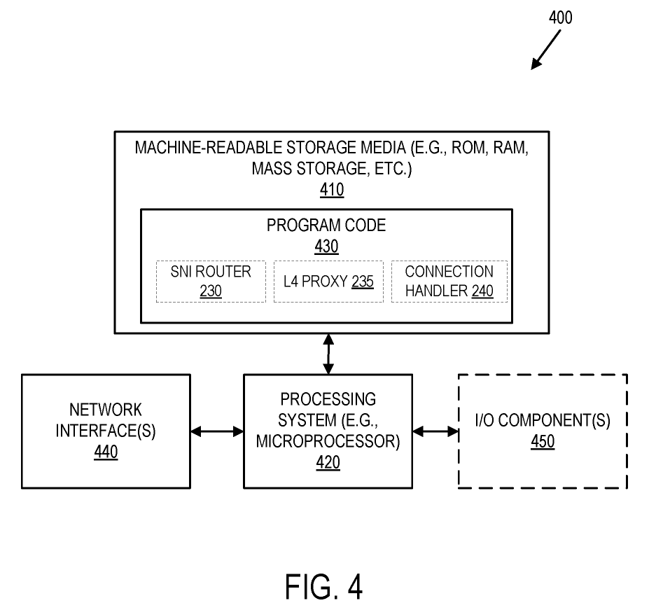

FIG. 4 illustrates a block diagram for an exemplary data processing system 400 that may be used in some embodiments. One or more such data processing systems 400 may be utilized to implement the embodiments and operations described with respect to the compute servers or other servers described herein. Data processing system 400 includes a processing system 420 (e.g., one or more processors and connected system components such as multiple connected chips).

The data processing system 400 is an electronic device that stores and transmits (internally and/or with other electronic devices over a network) code (which is composed of software instructions and which is sometimes referred to as computer program code or a computer program) and/or data using machine-readable media (also called computer-readable media), such as machine-readable storage media 410 (e.g., magnetic disks, optical disks, read only memory (ROM), flash memory devices, phase change memory) and machine-readable transmission media (also called a carrier) (e.g., electrical, optical, radio, acoustical or other form of propagated signals – such as carrier waves, infrared signals), which is coupled to the processing system 420. For example, the depicted machine-readable storage media 410 may store program code 430 that, when executed by the processing system 420, causes the data processing system 400 to execute the SNI router 230, L4 proxy 235, the connection handler 240, and/or any of the operations described herein.

The data processing system 400 also includes one or more network interfaces 440 (e.g., a wired and/or wireless interfaces) that allows the data processing system 400 to transmit data and receive data from other computing devices, typically across one or more networks (e.g., Local Area Networks (LANs), the Internet, etc.). The data processing system 400 may also include one or more input or output (“I/O”) components 450 such as a mouse, keypad, keyboard, a touch panel or a multi-touch input panel, camera, frame grabber, optical scanner, an audio input/output subsystem (which may include a microphone and/or a speaker), other known I/O devices or a combination of such I/O devices. Additional components, not shown, may also be part of the system 400, and, in certain embodiments, fewer components than that shown in One or more buses may be used to interconnect the various components shown in FIG. 4.

In the preceding description, numerous specific details are set forth to provide a more thorough understanding. It will be appreciated, however, by one skilled in the art that embodiments may be practiced without such specific details. In other instances, control structures, gate level circuits and full software instruction sequences have not been shown in detail in order not to obscure understanding. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described.

The techniques shown in the figures can be implemented using code and data stored and executed on one or more electronic devices (e.g., a compute server). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals – such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment of the invention may be implemented using different combinations of software, firmware, and/or hardware.

While the flow diagrams in the figures show a particular order of operations performed by certain embodiments of the invention, such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a first server of a plurality of servers of a distributed cloud computing network, comprising:
receiving a secure session request as part of a secure session handshake, wherein the secure session request includes a Server Name Indication (SNI) field, and wherein the secure session request originates from a client network application;
determining a hostname from the SNI field;
determining that a policy is applicable for the determined hostname, wherein the determined policy indicates a first location where decrypting and servicing traffic for the determined hostname is permitted;
determining that a second location of the first server does not satisfy the determined policy;
proxying the secure session handshake between the client network application and a second server of the distributed cloud computing network that satisfies the determined policy, wherein a successful secure session handshake creates a secure session between the client network application and the second server; and
proxying layer 4 traffic transmitted over the secure session between the client network application and the second server.

2. The method of claim 1, wherein the first location is a region.

3. The method of claim 1, wherein the secure session request is a ClientHello message.

4. The method of claim 1, wherein the secure session request is received at the first server of the plurality of servers of the distributed cloud computing network due to an anycast implementation.

5. The method of claim 1, further comprising:
determining that a certificate for the determined hostname is a dedicated certificate that does not cover any other hostname.

6. The method of claim 1, wherein proxying the secure session handshake between the client network application and the second server of the distributed cloud computing network includes:
transmitting the secure session request to the second server;
receiving a response to the secure session request from the second server; and
transmitting the response to the secure session request to the client network application.

7. The method of claim 6, wherein transmitting the secure session request to the second server includes transmitting a client IP address, a client port, a server IP address, and a server port of the secure session request.

8. A non-transitory machine-readable storage medium that provides instructions that, if executed by a processing system of a first server of a plurality of servers of a distributed cloud computing network, will cause said first server to perform operations comprising:
receiving a secure session request as part of a secure session handshake, wherein the secure session request includes a Server Name Indication (SNI) field, and wherein the secure session request originates from a client network application;
determining a hostname from the SNI field;
determining that a policy is applicable for the determined hostname, wherein the determined policy indicates a first location where decrypting and servicing traffic for the determined hostname is permitted;
determining that a second location of the first server does not satisfy the determined policy;
proxying the secure session handshake between the client network application and a second server of the distributed cloud computing network that satisfies the determined policy, wherein a successful secure session handshake creates a secure session between the client network application and the second server; and
proxying layer 4 traffic transmitted over the secure session between the client network application and the second server.

9. The non-transitory machine-readable storage medium of claim 8, wherein the first location is a region.

10. The non-transitory machine-readable storage medium of claim 8, wherein the secure session request is a ClientHello message.

11. The non-transitory machine-readable storage medium of claim 8, wherein the secure session request is received at the first server of the plurality of servers of the distributed cloud computing network due to an anycast implementation.

12. The non-transitory machine-readable storage medium of claim 8, wherein the operations further comprise:
determining that a certificate for the determined hostname is a dedicated certificate that does not cover any other hostname.

13. The non-transitory machine-readable storage medium of claim 8, wherein proxying the secure session handshake between the client network application and the second server of the distributed cloud computing network includes:
transmitting the secure session request to the second server;
receiving a response to the secure session request from the second server; and
transmitting the response to the secure session request to the client network application.

14. The non-transitory machine-readable storage medium of claim 13, wherein transmitting the secure session request to the second server includes transmitting a client IP address, a client port, a server IP address, and a server port of the secure session request.

15. A first server of a plurality of servers of a distributed cloud computing network, the first server comprising:
a processing system; and
a non-transitory machine-readable storage medium that provides instructions that, if executed by the processing system, will cause said first server to perform operations including:
receiving a secure session request as part of a secure session handshake, wherein the secure session request includes a Server Name Indication (SNI) field, and wherein the secure session request originates from a client network application,
determining a hostname from the SNI field,
determining that a policy is applicable for the determined hostname, wherein the determined policy indicates a first location where decrypting and servicing traffic for the determined hostname is permitted,
determining that a second location of the first server does not satisfy the determined policy,
proxying the secure session handshake between the client network application and a second server of the distributed cloud computing network that satisfies the determined policy, wherein a successful secure session handshake creates a secure session between the client network application and the second server, and
proxying layer 4 traffic transmitted over the secure session between the client network application and the second server.

16. The first server of claim 15, wherein the first location is a region.

17. The first server of claim 15, wherein the secure session request is a ClientHello message.

18. The first server of claim 15, wherein the secure session request is received at the first server of the plurality of servers of the distributed cloud computing network due to an anycast implementation.

19. The first server of claim 15, wherein the operations further comprise:
determining that a certificate for the determined hostname is a dedicated certificate that does not cover any other hostname.

20. The first server of claim 15, wherein proxying the secure session handshake between the client network application and the second server of the distributed cloud computing network includes:
transmitting the secure session request to the second server;
receiving a response to the secure session request from the second server; and
transmitting the response to the secure session request to the client network application.

21. The first server of claim 20, wherein transmitting the secure session request to the second server includes transmitting a client IP address, a client port, a server IP address, and a server port of the secure session request.
